(19) United States
(12) Patent Application Publication
(10) Pub. No.: US 2007/0034654 A1
(43) Pub. Date: Feb. 15, 2007

(54) Water spray gun

(75) Inventor: Ho-Hsin Liao, Taipei (TW)

Correspondence Address: BACON & THOMAS, PLLC, 625 SLATERS LANE, FOURTH FLOOR, ALEXANDRIA, VA, 22314, US

(73) Assignee: BENEXT INNO-PRODUCT DEVELOPMENT LTD., Taipei (TW)

(21) Appl. No.: 11/257,011

(22) Filed: Oct. 25, 2005

(30) Foreign Application Priority Data
Aug. 12, 2005 (TW) 094127649

(51) Int. Cl. B67D 3/00

(52) U.S. Cl. 222/527

(57) ABSTRACT

A water spray gun mainly includes a water spray gun body and an electronic device. The function of the water spray gun body just like those of prior water spray gun bodies, that is a hose is connected to the water spray gun and through which water can be sprayed. However, the shape of the water spray gun body prefers to be like a toy gun. The electronic device provides sound, or light effect to generate entertainments.

### BACKGROUND OF THE INVENTION

1. Pattern of the Invention

The present invention relates to a water spray gun, and more particularly, to a water spray gun for gardening or car washing.

2. Description of the Related Art

Water spray guns used for gardening or in car washes have been available for more than 50 years, and the main differences between the various designs include variations in nozzle design, different button designs or different valve designs. The prior art designs primarily concern the capabilities of the water spray, and not the entertainment of the gun.

Therefore, it is desirable to provide a water spray gun to mitigate and/or obviate the aforementioned problem.

### SUMMARY OF THE INVENTION

A main objective of the present invention is to provide an interesting water spray gun. Most of the users of water spray gun are adults. An interesting water spray gun will increase the using motivation of children, and therefore, children will help housework more.

Another objective of the present invention is to provide a water spray gun with two handles so that a user can use two hands to share the weight of the water spray gun. Furthermore, the water spray gun can have a toy gun shape to produce entertaining effects.

In order to achieve the above-mentioned objectives, the water spray gun of the present invention comprises a water spray gun body and an electronic device. The function of the water spray gun body just like those of prior water spray gun bodies, that is a hose is connected to the water spray gun and through which water can be sprayed. However, the shape of the water spray gun body prefers to be like a toy gun.

The water spray gun body may be a standard water spray gun body, capable of connecting to a hose to spray water, but the water spray gun body preferably has the shape of a toy gun.

The electronic device provides sound, or light effect to generate entertainments. The electronic device is used to provide the sound, or light effect when the user presses the button to spray water. Therefore, the electronic device comprising a trigger switch, and the button is able to actuate the trigger to control the speaker.

In one embodiment of the present invention, the water spray gun body has a toy gum shape and two handles so that a user can hold the water spray gun with two hands.

Other objects, advantages, and novel features of the invention will become more apparent from the following detailed description when taken in conjunction with the accompanying drawings.

### BRIEF DESCRIPTION OF THE DRAWINGS

FIG. 1 illustrates a water spray gun in a first embodiment according to the present invention.

FIG. 2 is a cross-sectional drawing of a first embodiment water spray gun of the present invention.

FIG. 3 illustrates a water spray gun in a second embodiment according to the present invention.

### DETAILED DESCRIPTION OF THE PREFERRED EMBODIMENT

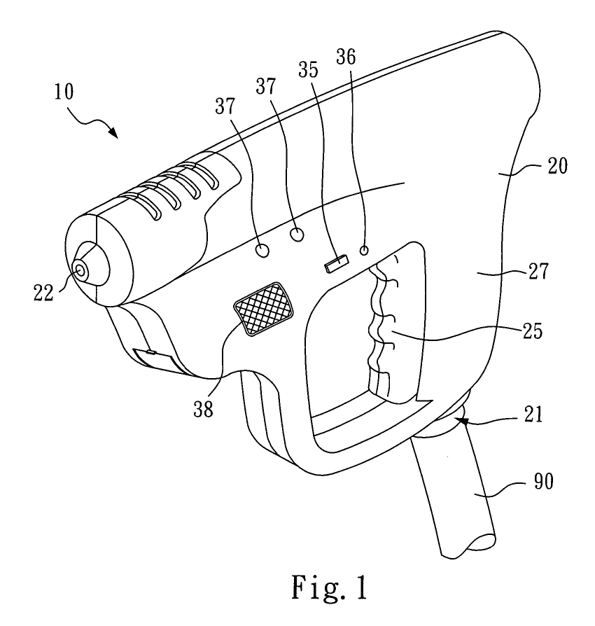

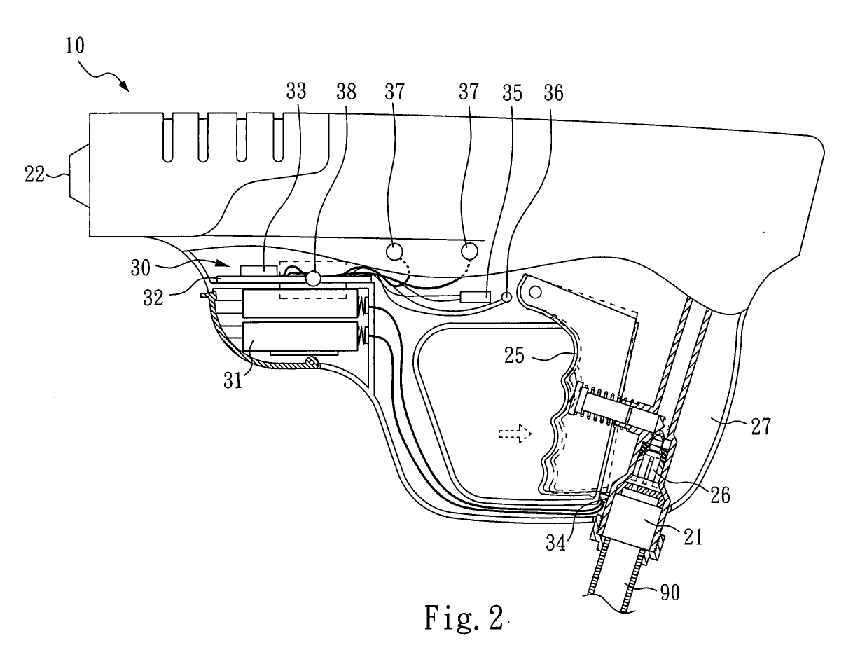

Please refer to FIG. 1 and FIG. 2. A water spray gun 10 of the present invention comprises a water spray gun body 20 and an electronic device 30. The water spray gun body 20 may be a standard water spray gun body, capable of connecting to a hose 90 to spray water, but the water spray gun body 20 preferably has the shape of a toy gun. The water spray gun body 20 comprises a water inlet 21, a nozzle 22, a button 25, a handle 27, and an inlet valve 26. The hose 90 may be connected to the water inlet 21, and the button 25 is used to control the inlet valve 26 to control the flow of water through the nozzle 22. Since the water spray gun body 20 is a very well known technology, it requires no further description.

A characteristic of the present invention is that the water spray gun 10 further comprises an electronic device 30, and the electronic device 30 is mounted in the water spray gun body 20. The electronic device 30 is used to provide audio effects and lighting effects for the amusement of users, particularly children. The electronic device 30 comprises a power source 31 (such as a battery, or a generator powered by flowing water), a control circuit 32, a sound chip 33, one or more function keys 36, one or more ornamental lamps 37 and at least one speaker 38. The control circuit 32 may be implemented as a single electronic chip to control the electronic device 30. The sound chip 33 is not necessary, but may provide more interesting audio effects. The music chip 33 may store more than one type of audio effect, and a user can select different audio effects with the function key or keys 36 (it will be appreciated that even a single button may to switch different audio effects). Moreover, the electronic device 30 may also provide vibration effects (which may be implemented by adding a vibrator, which is not shown). Because the water spray gun 10 is typically used during daylight hours and outdoors, the speaker 38 may be more important than the ornamental lamp 37. As many toy guns exist on the market that have electronic devices that provide audio and lighting effects, no further detailed description of the electronic devices is required.

So the speaker 38 provides audio effects when the user presses the button 25, the electronic device 30 further comprises a trigger switch 34 which is located near the button 25. When the button 25 is pressed, the trigger switch 34 is also activated to cause the speaker 38 to provide audio effects, or to cause the ornamental lamp 37 to flash. The electronic device 30 preferably has a primary switch 35 so that a user (such as a parent instead of a child) can switch off the power source 31 to disable the speaker 38 or the ornamental lamp 37.

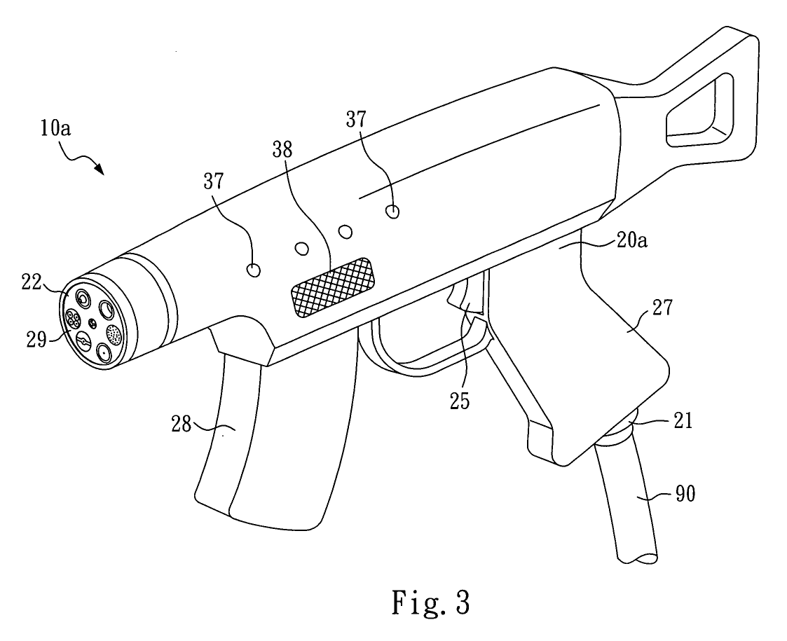

Please refer to FIG. 3. FIG. 3 shows a water spray gun in a second embodiment according to the present invention. In this embodiment, the water spray gun body 20a of the water spray gun 10a has not only the back handle 27, but also a front handle 28 so that a user may hold the water spray gun 10a with two hands. The nozzle 22 of the water spray gun body 20a may have an adjustable nozzle 29 so that the water spray gun 10a can spray water in different ways. However, the adjustable nozzle 29 is a well known technology, examples of which may be found, for example, in U.S. Pat. No. 5,501,400.

Because the water spray gun works with water, the electronic device 30 should have water-proofing to shield the electronic device 30 from water; such water-proofing is also a well know technology, and thus requires no further description.

Although the present invention has been explained in relation to its preferred embodiment, it is to be understood that many other possible modifications and variations can be made without departing from the spirit and scope of the invention as hereinafter claimed.

What is claimed is:

1. A water spray gun capable of connection to a hose for spraying water, the water spray gun comprising:
a water spray gun body comprising:
a water inlet adapted for connection to the hose;
a nozzle;
an inlet value;
a button for controlling the inlet value to control water passing through the nozzle; and
an electronic device installed in the water spray gun, the electronic device comprising a trigger switch and at least one speaker, wherein the button is able to actuate the trigger to control the speaker.

2. The water spray gun as claimed in claim 1, wherein the electronic device further comprises a sound chip.

3. The water spray gun as claimed in claim 1, wherein the electronic device further comprises at least one ornamental lamp electrically connected to the trigger switch.

4. The water spray gun as claimed in claim 1, wherein the water spray gun body further comprises a back handle and a front handle so that a user can hold the water spray gun with two hands.

5. The water spray gun as claimed in claim 1, wherein the water spray gun has a toy gun shape.
